(19) United States
(12) Patent Application Publication
(10) Pub. No.: US 2007/0192305 A1
(43) Pub. Date: Aug. 16, 2007

(54) Search term suggestion method based on analysis of correlated data in three dimensions

(76) Inventors: William Derek Finley, Ottawa (CA); Christopher William Doylend, Ottawa (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 11/698,898

(22) Filed: Jan. 29, 2007

Related U.S. Application Data
(60) Provisional application No. 60/762,514, filed on Jan. 27, 2006.

(51) Int. Cl. G06F 17/30

(52) U.S. Cl. 707/4

(57) ABSTRACT

An enhanced search engine compares a received search query with a history of previous search queries. When equivalent search queries are found the search engine provides a set of sub-categories to the user to further refine their search. Optionally a sub-category corresponds to a specific result. These sub-categories and results are optionally displayed along with conventional search results.

This application claims the benefit of U.S. Provisional Application No. 60/762,514, filed on Jan. 27, 2006, the entire contents of which are incorporated herein by reference.

### FIELD OF THE INVENTION

The instant invention relates generally to data searching, and more particularly to a method for reducing search space complexity based on additional search terms that are suggested in dependence upon the analysis of highly correlated communal information.

### BACKGROUND

Data storage, analysis, retrieval and display have always been important aspects of computers. Although different data retrieval and data display models have been proposed over the years, most system designers return to one of three models due to their simplicity, ease of use, and user comprehensibility. These three models include the desktop model, the list based model, and the hierarchical list model.

The desktop model was popularized by Apple® with its Macintosh® computers, and is used to display computer operating system data in a virtual desktop environment. On a computer screen is shown an image of a two-dimensional desktop with files, folders, a trashcan, and so forth being represented by different icons that are arranged in some manner on the “surface” of the desktop. To access files that are stored on the computer system, a user simply selects an appropriate icon from the desktop display. Though the desktop model is convenient and intuitive, it is often difficult to implement due to system level constraints. For example, the Windows® operating system that is provided by Microsoft® Corporation has limitations on file name length and, as such, is sometimes unable to store files sufficiently deeply within nested folders to truly reflect the desktop based model. Further, since some systems are more limited than others, the model when implemented results in some limitations on portability. For many applications and for application execution, the desktop model is often poor.

Also, though the desktop model is well suited to providing user references for many different functions, it is poorly suited for organizing large volumes of data since it has no inherent organizational structure other than the one that is set by a user. Thus, similar to actual physical desktops, some virtual desktops are neat and organized while others are messy and disorganized. Thus, for data organization and retrieval, the virtual desktop model is often neutral—neither enhancing nor diminishing a user's organizational skills.

The list-based model is employed in all aspects of daily life. For instance, music organization programs display music identifiers such as titles and artists in a list that is sortable and searchable based on many different criteria. Typically, sort criteria are displayed as column headers allowing for easy searching based on the column headers. Many applications support more varied search criteria and search definition.

Another example of list based data display is Internet search engines, which typically show a list of results for a provided search query. The results are then selectable for navigating to a World Wide Web Site relating to the listed result. Unfortunately, with the wide adoption of the World Wide Web and with significant attempts to get around search engine technology—to “fool” the search engines—it is often difficult to significantly reduce a search space given a particular query. For example, the search term “fingerprint” returns a significant number of results for biometric based fingerprinting similar to that used by police and a significant number of results for genetic fingerprinting using DNA. These results are distinct one from another.

The hierarchical list is similar to the list-based model but for each element within a higher-level list, there exist further sub-items at a lower level. Thus, a first set of folders allows for selection of a folder having within it a set of subfolders, etc. This allows for effective organization of listed data. In the above noted music list program example, classical music is optionally stored in a separate sub list from country music, etc.

Some complex data structures, such as for instance the organizational charts of large corporations, or of other similarly organized bodies such as for instance government or military units, consist of interconnected and highly correlated nodes. For instance, hierarchal organization charts of a large corporation may include a separate chart for each different unit of the corporation, with individuals and/or departments in each unit being represented as separate nodes in the chart, and with relationships between the separate nodes in the chart being shown as interconnections in two-dimensions. That said, it is often the case that relationships exist between individuals and/or departments in different units of the corporation, and accordingly the nodes of one chart actually are interconnected with the nodes of one or more of the other charts. Furthermore, it is often the case that different types of relationships exist between the nodes, such as for instance reporting relationships, communication relationships, financial relationships, etc. Unfortunately, current methods for analyzing and visualizing such highly correlated sets of data do not produce results that are intuitive to the user, and as a result the analysis is cumbersome and prone to errors and the visualization is confusing and prone to omissions.

Similar problems are associated generally with other types of highly correlated sets of data. For instance, in a computer system such as the Internet a plurality of users provide, on a daily basis, various types of information relating to their preferences, habits, demographic identity, etc. In fact, the number of users is extremely large in the case of the Internet, representing geographically diverse individuals over a broad range of demographic categories. Some attempts have been made to poll the users in order to obtain a pool of information that is useful in an e-commerce environment. However, typically such polling attempts are limited to individual sites, and the value of such information depends largely upon the accuracy and the honesty of the users.

It is also the case that, with every click of a mouse button, the users are providing some form of information about themselves. For instance, by selecting certain music compact disks (CDs) from a list, reading reviews for certain movies, providing opinions via certain web log (BLOG) sites, etc., the user is providing a wealth of information. As mentioned supra, current methods for analyzing and visualizing such highly correlated sets of data do not produce results that are intuitive to the user, and as a result the analysis is cumbersome and prone to errors and the visualization is confusing and prone to omissions.

Clearly, as the World Wide Web continues to increase in size it becomes more difficult for people to find what they are looking for.

It would be advantageous to provide a method that overcomes at least some of the above-mentioned limitations of the prior art.

### SUMMARY OF EMBODIMENTS OF THE INSTANT INVENTION

According to an aspect of the instant invention there is provided a method1. A method of searching for content that is stored on a computer system, comprising: providing an initial search query; displaying a representation of a search space in dependence upon the initial search query, the search space comprising a plurality of data labels indicative of sub-categories that are related to the initial search query, and being selected based on an analysis of the progression of prior searches having in common a same initial search query; selecting at least one of the data labels of the search space, so as to as to generate a next search space of reduced complexity; and, displaying a representation of the next search space.

In accordance with another aspect of the invention there is provided a method of searching for content that is stored in a memory of a computer system, comprising: receiving an initial search query that is provided by a searcher; retrieving from the memory a set of data relating to results previously generated in dependence upon a same initial search query; retrieving other data from the memory, the other data relating to a progression of prior searches having in common the same initial search query; analyzing the set of data and the other data to determine a plurality of sub-categories that are related to the initial search query, the sub-categories for providing the searcher with options to refine the search query; displaying a representation of the search space for the initial search query, the search space comprising a plurality of data labels, each one of the plurality data labels indicative of one of the determined plurality of sub-categories; and, in response to the searcher selecting one of the data labels distributed on the surface of the three-dimensional solid shape, restricting the search space for the initial search query to those results within the sub-category associated with the selected data label.

In accordance with another aspect of the invention there is provided a computer-readable storage medium having stored thereon computer-executable instructions for performing a method of searching for content that is stored on a computer system, the method comprising: receiving an initial search query that is provided by a searcher; retrieving from a memory a set of data relating to results previously generated in dependence upon a same initial search query; retrieving other data from the memory, the other data relating to a progression of prior searches having in common the same initial search query; analyzing the set of data and the other data to determine a plurality of sub-categories that are related to the initial search query, the sub-categories for providing the searcher with options to refine the search query; displaying a representation of the search space for the initial search query, the search space comprising a plurality of data labels, each one of the plurality data labels indicative of one of the determined plurality of sub-categories; and, in response to the searcher selecting one of the data labels distributed on the surface of the three-dimensional solid shape, restricting the search space for the initial search query to those results within the sub-category associated with the selected data label.

### BRIEF DESCRIPTION OF THE DRAWINGS

Exemplary embodiments of the invention will now be described in conjunction with the following drawings, in which similar reference numerals designate similar items:

FIG. 1A is a simplified schematic of a listing of songs by a prior art search engine in response to a user query;

FIG. 1B is a simplified schematic of an alternate listing of the same songs by a prior art search engine in response to a change in the user's filtering of the results from a query;

FIG. 1C is a simplified schematic of a second alternate listing of the same songs by a prior art search engine in response to a change in the user's filtering of the results from a query;

FIG. 2 is a simplified schematic of a more detailed listing of the same songs by a prior art search engine in response to a user's query;

FIG. 3A is a simplified schematic of listing the same songs in a first embodiment of the invention;

FIG. 3B is a simplified schematic of an alternate representation of the search results, presented by an embodiment of the invention, by the query in response to a refinement of the criteria entered by the user;

FIG. 4 is a simplified schematic of an embodiment of the invention wherein the results of a query to the World Wide Web for “FINGERPRINTS” is represented;

FIG. 5 is a simplified schematic of an alternative representation of the search results presented by an embodiment of the invention, wherein the user has highlighted an area of interest; and,

FIG. 6 is a simplified schematic of a further refinement of the search in response to user input using an embodiment of the invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

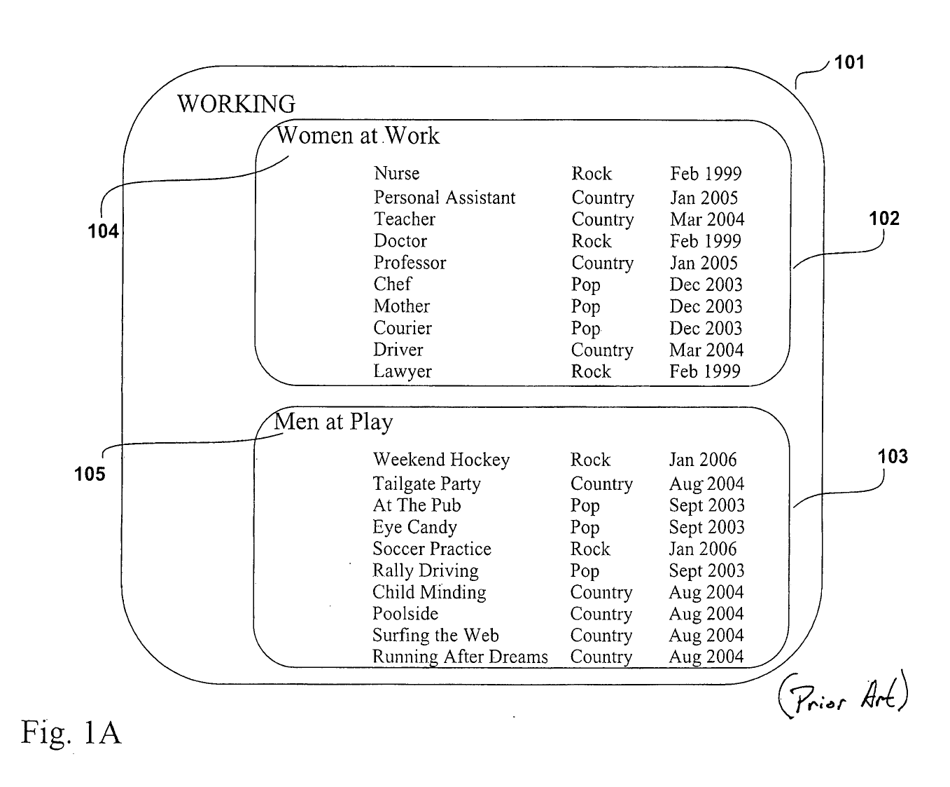

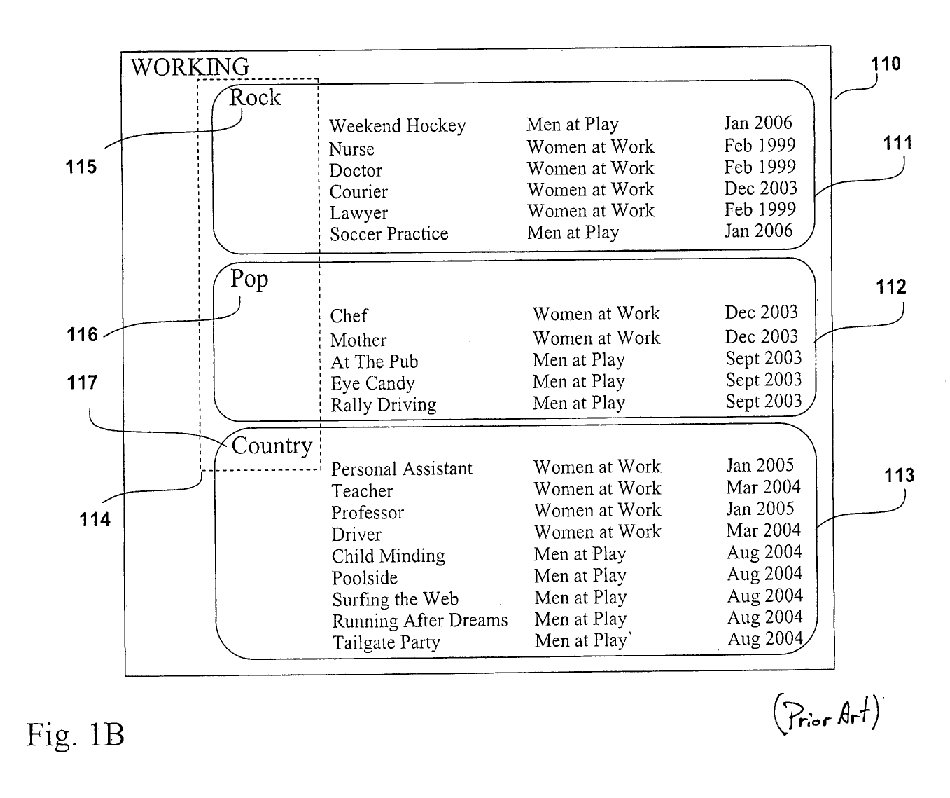

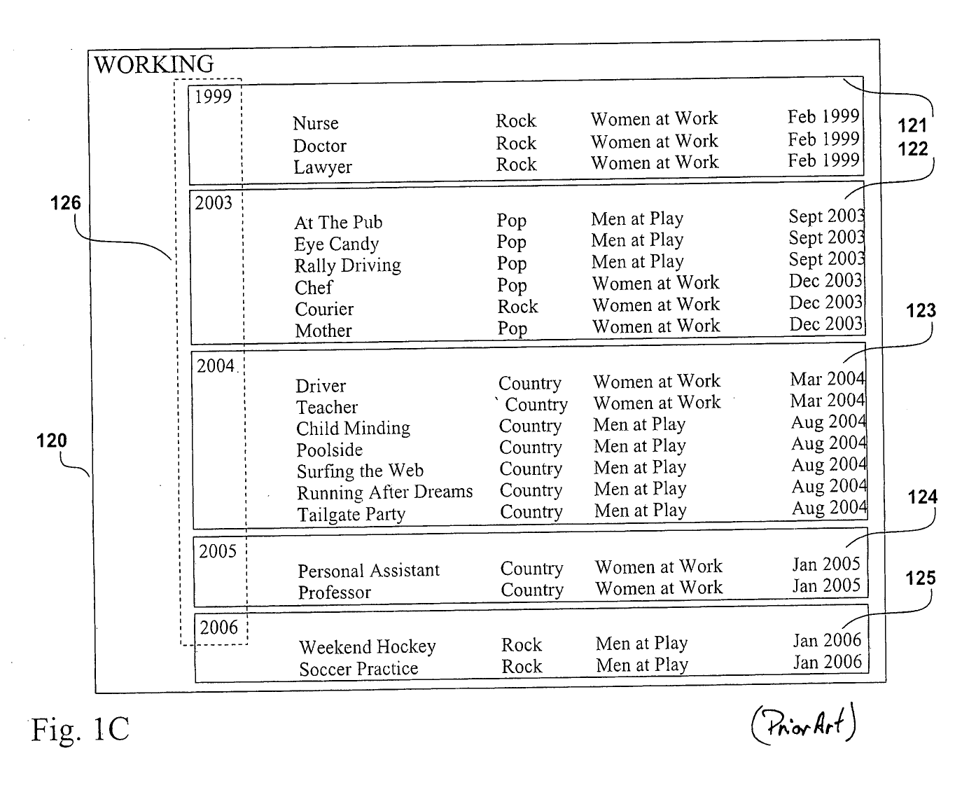

Referring to FIG. 1a, shown is a prior art music program listing for WORKING 101 having displayed 20 data entries. Such a display may be generated within many different applications, generally Internet based, such as radio stations, libraries, online music retailers and record companies. As is evident, the songs are grouped into two groups representing 10 songs from each artist, “Women at Work” 104 and “Men at Play” 105. As is evident, for each song only a single artist is supported.

Using a typical prior art software application and website providing the information, the user may adjust the listing based upon a different criterion, such as genre. Referring to FIG. 1b, the same 20 songs presented in FIG. 1a are now shown sorted by genre 114. As is evident, three different genres ROCK 115, POP 116 and COUNTRY 117 were returned by the search WORKING 110. Within each genre is a listing 111-113 of the songs that were returned by the search WORKING 110. In this example, each song appears in only one genre 111-114, but this is not immediately obvious to the user.

Further the user may choose alternative, albeit similarly structured views, such as is shown in FIG. 1C wherein the user has now selected YEAR 126 for filtering and displaying the results of the search WORKING 120. In this example the songs are displayed in chronological sequence using the YEAR 126 to group results. Now for each YEAR 126 there is a group of songs listed 121-125. Further within each year the songs are displayed by month.

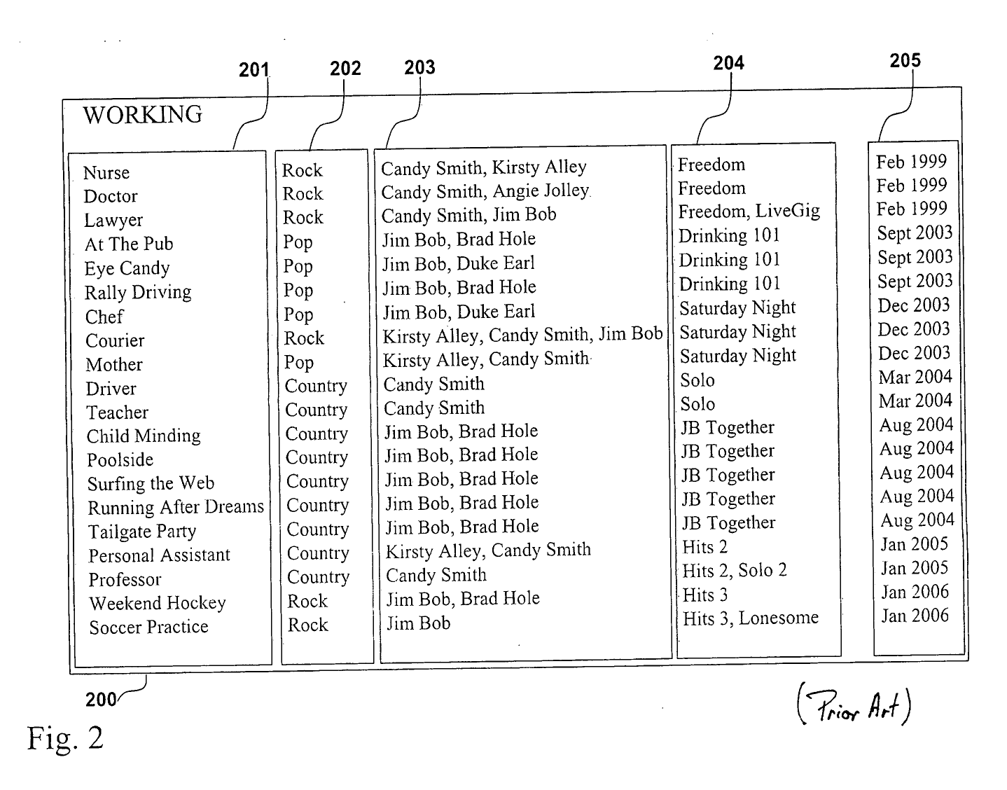

Referring to FIG. 2, shown is a listing WORKING 200 of the same 20 song titles but now displaying name 201 genre 202, artist(s) 203, album title 204 and date 205. It is evident in this list that some songs are attributed to several artists, less so that some artists have worked with different other artists on different songs. Further, some songs are from different albums including some songs being on two or more albums. It is further possible, but not shown here, that some songs are written by or belong (in terms of copyright) to more than one person, that person is not an artist and hence not filtered by artist, and the songs are in more than one collection. [Confusing and unclear] Of course, some songs have more than one genre attributed thereto, as they appear on for instance an artist's own album as well as an annual compilation. Display and sorting of the data is rendered more difficult due to all of the additional information. That said, searching of the data is facilitated, though search results often include too many “hits” for convenience.

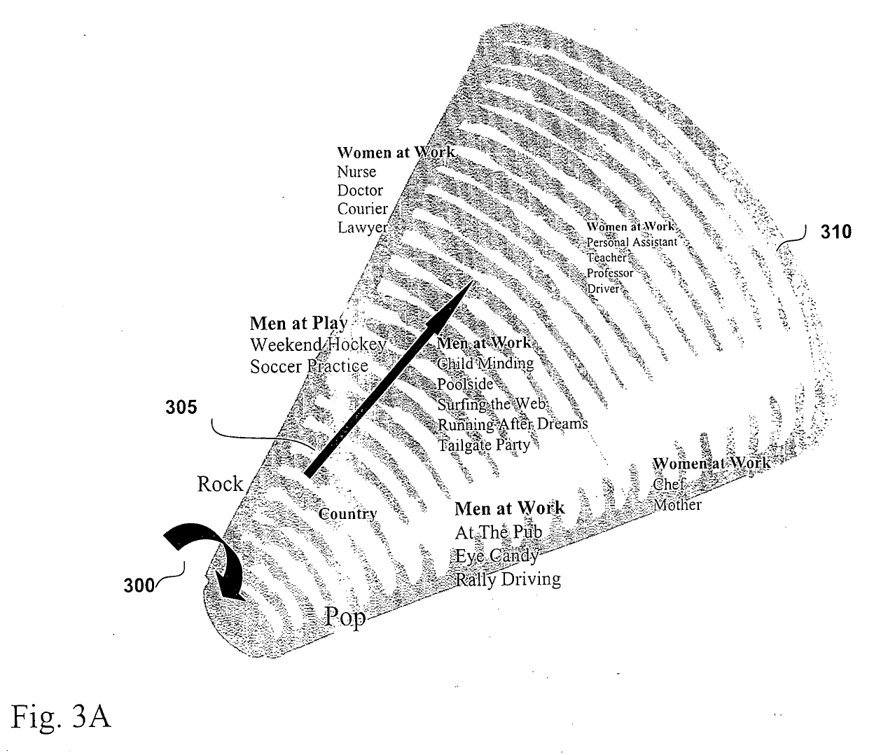

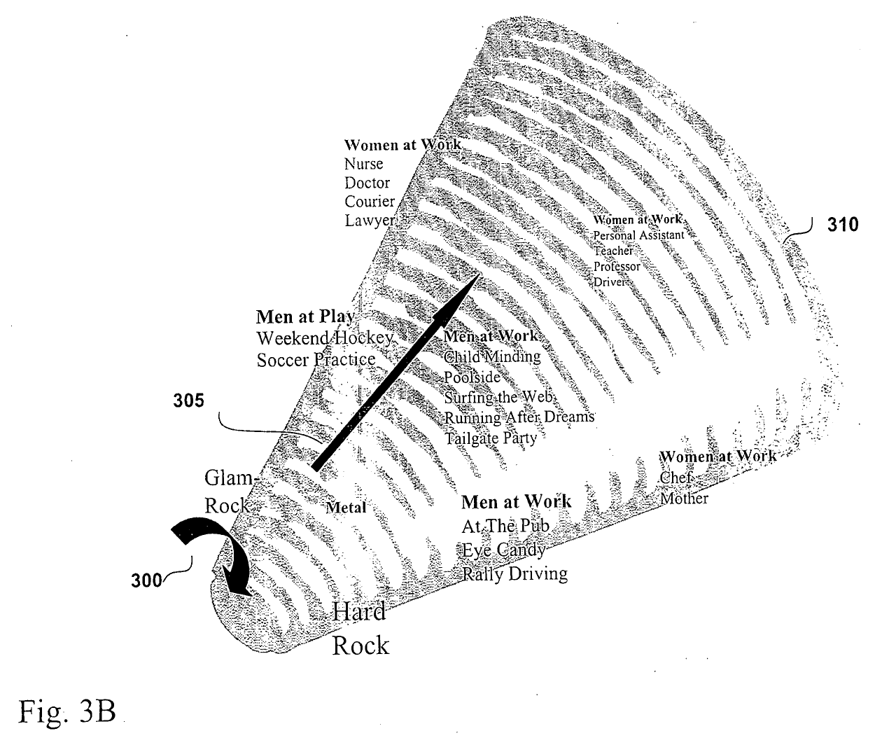

Referring to FIG. 3A, shown is a three-dimensional listing of the data of FIG. 2. Here, the data is distributed on a surface of a cone 310 for simplicity of discussion, though any of a number of three-dimensional representations is supported. The songs are sorted in accordance with some aspect thereof and then represented accordingly. Alternatively, the data is not pre-sorted. As shown in FIG. 3A, the songs are sorted by genre around the cone 300 and by artist along a linear axis of the cone 305. Thus, artists with names beginning with A appear higher on the cone. Further, the genre POP is shown at a front of the cone while ROCK is to the left and COUNTRY is to the back of the cone 310. Songs displayed on the surface of the cone are therefore aligned based on aspects of similarity. Hence, songs that are COUNTRY-ROCK are dispersed on an upper-rearward facing side of the cone. Songs that are POP-ROCK are on the front surface at the right hand side. Those that are POP-COUNTRY appear on the front face to the left side.

Although the display of the songs appears in many ways to be an arbitrarily different one, nevertheless the three-dimensional model shown demonstrates many significant advantages over the prior art. For example, when a user's favorite songs tend to be to within a particular genre then rotating the cone surface results in a better view of likely song candidates. Further, by either displaying the data on a different three-dimensional view or with a different sorting allows for the data to be manipulated—rotated or traversed—to find correlated data according to a user perspective. For example, when a commercial enterprise such as the iTunes Store® provides its music data in such a format, a user is able to visually see songs that are in accordance with search criteria sorted according to many criteria simultaneously, and manipulatable according to those criteria and refinements thereof.

So for example, the rotation of the cone to bring ROCK forward onto the surface prompts the application providing the visual representation of the search results to change the dataset in accordance with the current direction of the search. Therefore, in this case directing the search towards ROCK results in a second viewpoint being presented as shown in FIG. 3B. Now the surface of the cone reflects sub-sections of the broad genre ROCK, shown herein as GLAM-ROCK, HARD-ROCK and METAL. In such a manner the listed song titles would be re-displayed according to this next sub-set of search criteria. The user could repeat this, for example seeking a GLAM-ROCK song by an artist beginning with the letter A the search could be directed to the left tip surface of the cone.

Thus, even though a search for music by a particular artist returns many songs, they are arranged in proximity to those songs of similar characteristics. A user is then able to identify the songs they know and like and those they dislike and to select or purchase songs that are similar to those they like.

Similarly, for display of music related search results, the method provides a convenient process for grouping search results to allow for ease in selection of songs of interest and then, once selected, for identifying songs that are similar to the selected songs of interest. This is achievable in response to a search query, in response to entry of a number of songs, or in response to navigating a three-dimensional structure of nodes relating to music and grouped based on some correlative criteria. A person of skill in the art will appreciate that mapping a result onto a three-dimensional surface and providing a two dimensional image of the resulting surface is a convenient way of displaying information to a user because, in many cases, the user is able to appreciate that a given location of the three-dimensional structure conveys information to the user when that location is properly interpreted. It will also be appreciated by one of skill in the art that other models are optionally chosen to assist in the presentation of data. For example, search results are optionally provided in a specific color for a specific criteria. Thus, in the case of displaying music results as per the embodiment described with reference to FIG. 3A, the color of a given song title is optionally chosen in dependence upon the year it was recorded. Additionally, the font size used to display the song title is chosen in dependence upon a total number of sales of the song. In this way, a user searching for specific information is guided to that information more efficiently because the search results provide additional information. Similarly, while the embodiment of the invention shown with reference to FIG. 3A shows results mapped onto a cone shape, this need not be the case. The search results are optionally mapped onto a flat surface. Clearly, the nature of the mapping of the results varies. Optionally, the user chooses how the search results are presented.

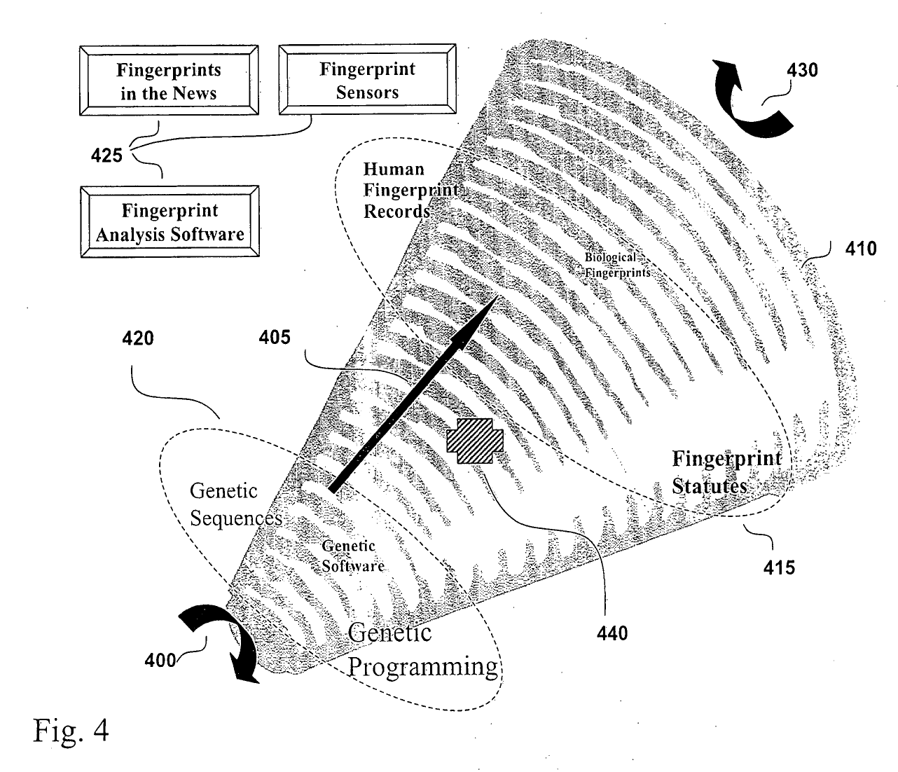

Referring to FIG. 4, shown is a three-dimensional search result display for use, for example, with an Internet search engine. Here a search of FINGERPRINTS has resulted in a very large list of potential “hits.” The potential “hits” are then correlated amongst themselves based on other characteristics, which in the first search by a user might be established by the Internet search engine itself using internally predetermined associations. Preferably, characteristics having effective grouping results are relied upon. Optionally, these characteristics are automatically determined in accordance with available data.

For the search FINGERPRINTS, the resulting search results are shown again on a surface of a cone. It would be evident to those skilled in the art that any of a number of three-dimensional representations is optionally supported for displaying the results. Additionally the three-dimensions representation might itself be determined in response to the search such that the display presents on surfaces reflecting the grouping or structure of the results. Hence, it can be envisaged that some searches return results better suited to say a sphere, than to say a pyramid, cone, rod or other shape. Equally the three dimensional representation might change as a user progresses with refining the search further as the degrees of separation between search results reduce.

At the front of the cone in this embodiment is shown fingerprint references having a relation to genetics 420. To the front the references relate to genetic programming and to the left the references relate to genetic sequences, whilst to the rear of the three-dimensional surface the search places results on genetic software, which have “hits” for FINGERPRINT but lower returned relevance than other results. However, should the user's search direct them in that direction then a quick rotation of the cone presents all those associated search results to the fore.

To the rear of the search result cone 410 are references to fingerprint analysis 415. The search space to the left being human fingerprint records, and to the right fingerprint law and statutes. To the rear surface of the cone the search places results on biological fingerprints, which for example include references to biological studies of fingerprints and their formation, or fingerprinting of another species such as chimpanzees.

Thus, the cone defines a search space about fingerprinting in general. A small list of alternative terms 425 is shown at the top to allow for changing of the cone to represent other fingerprint related topics such as fingerprints in the news, fingerprint analysis software, fingerprint sensors, etc. Alternatively, these topics are also represented within the cone.

Thus, rotation of the cone allows for a view that is related to an area of interest. For DNA sequence references the cone is rotated toward the left (arrow 400). For genetic programming the cone is rotated to the right (arrow 430).

The search results optionally are sorted on the surface of the three-dimensional representation, in this case a linear axis of the cone, based on a wide range of other critera, including for instance, date of the reference, relevancy score, etc. Of course, when a three-dimensional space is used in place of a three-dimensional surface; the search results are optionally sorted along each of three axes.

Optionally, as the cone is rotated, further search criteria relating to a current centered view are presented. Using these further search criteria allows for the search space to be reduced. As shown in FIG. 4, a hashed outline 440 demarks the restricted search space resulting from selection of a particular search criterion.

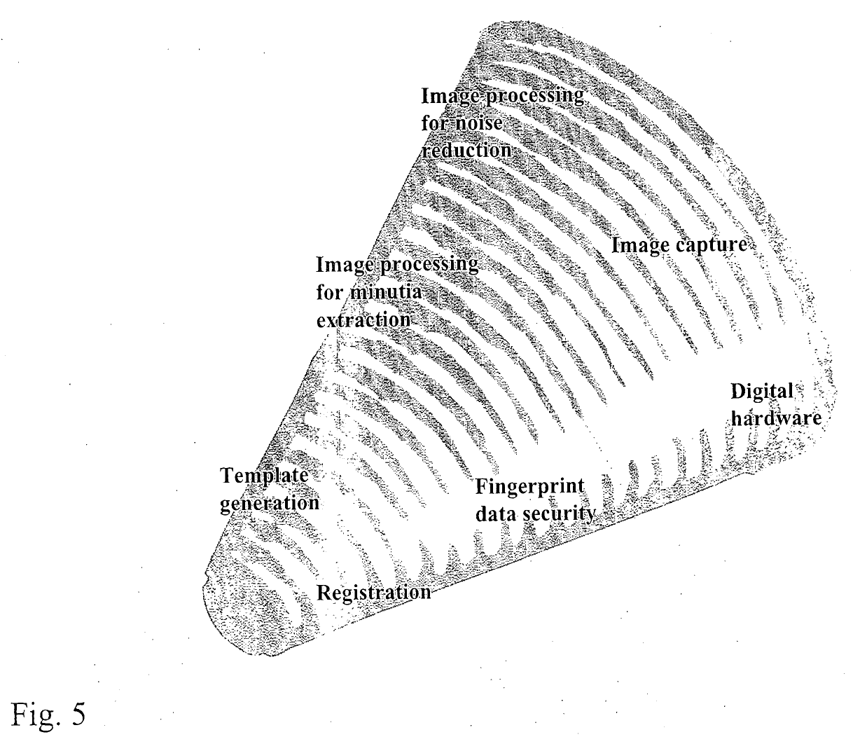

Although aligning of references along the surface of a cone makes it possible to indicate all correlation information, due to display limitations, sheer volume of data, and for user convenience, often it is simpler to display less information at a time, with a mechanism provided for drilling down into the data. Here, by restricting the search space further, a new displayed surface of a cone is presented as shown in FIG. 5 for digital fingerprint processing. In FIG. 5, different aspects of digital fingerprint processing—image processing for noise reduction, image processing for minutia extraction, template generation, registration, fingerprint data security, image capture, digital hardware, and so forth are each represented along the surface of the cone. Further search restriction is possible or, alternatively, expansion of the search scope is also supported.

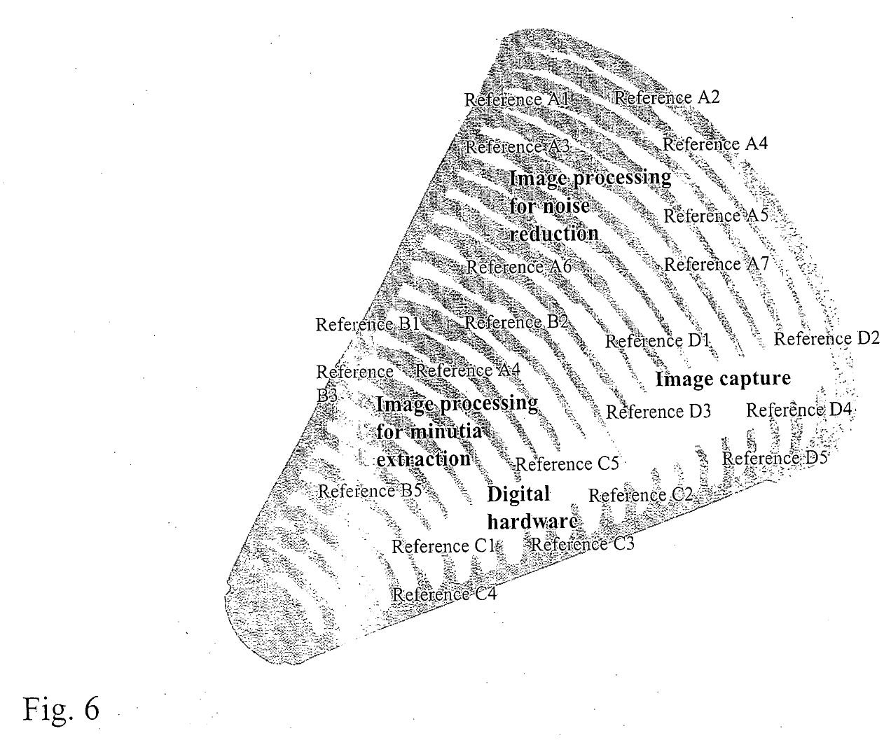

Referring to FIG. 6, a surface of a cone is shown with search results determined in accordance with an embodiment of the invention. The results are grouped by relevancy to a specific topic. Those topics are indicated as “Image processing for minutia extraction”, “Digital hardware”, “Image Capture” and “Image processing for noise reduction.” The results are shown in a fashion that displays references spatially such that the position indicated for a given reference is indicative of, for example, the field that the reference relates to. Each reference that relates to the four selected references is displayed in a sorted fashion about the cone's surface. As such, a selection of references of interest—varied or similar—allows for construction of a three dimensional search result relating to the four topics and therefore more in line with needs or specified desires of a user. Thus, the use of a display modeled after a three dimensional chart is advantageous as it not only allows for manipulation of the search result data but it also allows for search optimization and enhanced search tools. A person of skill in the art will appreciate that there are other ways of displaying such results in relation to a set of topics. For example, with four topics one optionally defines a virtual tetrahedron in which each of the four points of the tetrahedron corresponds to one topic. The location of a reference is chosen based upon its relevancy to a given topic. Thus a reference proximate a topic is closely related to that topic and a reference that is shown midway between two topics is categorized as being equally relevant to both topics. In either case, a user reviewing the search results is provided a clear indication of which references are relevant to which topic based upon the spatial representation. This serves to simplify searching. In addition, it allows a user to quickly find related references that deal with a specific combination of topics.

Alternatively, the three dimensional structure of the data being presented is spherical, a surface of a sphere, cubic, a surface of a cube, or placed in accordance with another algorithm, manually, or randomly within a three dimensional or hierarchical three dimensional space.

Preferably, a process for coupling and decoupling of elements within the three dimensional view is provided for grouping of elements or for entering correlative data relating to different elements. Further preferably, viewing processes include navigation tools for rotating, translating, and navigating the three-dimensional view space.

Another specific and non-limiting example of an application for the embodiments of the instant invention relate to Internet search engines—an application based on a highly correlated web of data—which include a feature to “suggest” additional search terms after an initial search query is executed. Accordingly, a process begins when a user provides a keyword or a string of keywords either with or without Boolean operators (AND being understood absent other operators being specified). The initial search is performed, and then choices are provided to the searcher for dividing the search space, the choices being determined based on an analysis of what other users have had as their final destination for the same initial search. The searcher may not initially know the precise nature of the information they are searching for, but by being offered some of the “most likely” choices as “suggestions,” the searcher effectively is directed toward the results they actually need. Clearly, different search criteria provide different categories of search results. In order to assist a user in narrowing their search criteria, a given search provides a user with categories of results, instead of specific results. Thus, in the case of FIG. 3A, rather than listing sets of music at specific locations on the cone, the criteria that would ordinarily be used to describe music positioned on the cone is provided along with the titles of songs consistent with those categories. Thus, the search result indicating “Men at Play, Weekend Hockey, Soccer Practice” would be accompanied by “Rock.” By clearly stating the criteria used to categorize the music, the user is made aware of those criteria. In some cases, the number of songs returned by a search is sufficiently large that displaying each of them would result in a cluttered display and thus, confusion for the user. In order to avoid this result, it is suggested that the song titles be omitted when the number of song titles is excessive so that the search criteria are clearly displayed. In this way, the user is provided the opportunity to refine their search criteria in a relatively intuitive fashion. Thus, selecting a specific region of a previous search output allows the searching system to conduct another search of a narrower field. This allows the user to quickly and intuitively refine their search criteria.

Alternatively, though the above embodiments are described with reference to known data associated with the displayed elements, it is also possible to organize data based on statistical data derived through analysis, such as with data mining, or derived from users via polling, queries, or community based information. For example, a community providing information such as blogs (World Wide Web logs), music communities, consumer communities, etc. Conveniently, when consumers each provide lists of products they enjoy, it is possible statistically to create a three-dimensional representation of products that are “similar” based on user provided data. Thus, if a user enters one or more products they like, a display of data relating to the one or more products is shown allowing the user to navigate through products that are statistically similar. Then by removing products that are deemed undesirable, the user affects the view to isolate products that are “similar” and acceptable. This, of course, also applies to music, to services, to films, to television broadcasts, and so forth. Similarly, when a set of search criteria is provided via a computer network, it is a simple matter to record the search criteria as well as data indicative of a progression of the corresponding search. In this way, a specific set of initial search criteria are associated with a set of histories and search outcomes. Optionally, a user conducting a search is provided access to the set of histories in order to simplify their own search. Optionally, the user provides their preference regarding what method is used to display results. Using search histories provides a variety of benefits. For example, given a statistically significant number of search histories it is a simple matter to determine if the search histories lead to a limited set of results. When this is the case, it is a simple matter to provide the limited set of results to the user as an outcome of the search criteria. Clearly, using a search engine this way is sensitive to a variety of factors. For example, if the user is looking for information regarding a very recent event it is unlikely that using search histories generated prior to the event will be beneficial in providing the desired result. Thus, a user wishing to determine the score of a sports event would not be interested in articles regarding the event that are written prior to the event. Thus, it is often desirable to separate search history results by date when it is believed that such time information is highly relevant. Thus, a given search result that makes use of histories projects the results onto a three dimensional surface where locations on the surface are time dependent.

In some cases, the use of related histories is beneficial in providing a set of categories from which the user may continue their search. Thus, users wishing to view astrological events are likely looking for a wide variety of different events yet a specific government server stores a variety of high quality media associated with such varied events and, as a result, a large percentage of previous searches of the same type lead to that government server. In this case, the user is provided the option of accessing the government server and refining their search from that point. In this example, the government server represents a sub-category of the search criteria, but not a specific result. Alternatively, the use of search histories leads the user to a plurality of sub-categories from which the user chooses a subset in order to refine their search.

Optionally, likely results and likely sub-categories as determined by a sample of search histories are provided along with conventionally determined search results. Thus, when a category or a specific search result is displayed, those results, which are consistent with search histories, are optionally indicated as being more likely to lead to a successful search. Further optionally, the user is requested to provide feedback to the search engine to determine a relative consistency of the search result with the desired result contemplated by the user. Thus, if a variety of users provide a same search criterion and follow a set of paths to a set of results that are not satisfactory the search engine is flagged to indicate that using search histories has not previously provided good results. Optionally such data is used to inhibit the use of search histories in refining a search. As the World Wide Web (WWW) continues to expand it is an increasing complex task to find desired data unless one already knows where to look. Clearly, by using search histories inexperienced users are able to benefit from more experienced users to find the information they seek.

Numerous other embodiments may be envisioned without departing from the spirit and scope of the invention.

What is claimed is:

1. A method of searching for content that is stored on a computer system, comprising:
a) providing an initial search query;
b) displaying a representation of a search space in dependence upon the initial search query, the search space comprising a plurality of data labels indicative of sub-categories that are related to the initial search query, and being selected based on an analysis of the progression of prior searches having in common a same initial search query;
c) selecting at least one of the data labels of the search space, so as to as to generate a next search space of reduced complexity; and,
d) displaying a representation of the next search space.

2. A method according to claim 1, comprising iterating b) and c) until the complexity of the search space is reduced to less than a predetermined limit.

3. A method according to claim 1, wherein the representation is an image corresponding to a view of a virtual three dimensional surface taken from a viewpoint and, wherein selecting one of the data labels of the search space comprises changing the viewpoint relative to the three-dimensional representation of the search space.

4. A method according to claim 3, wherein changing the viewpoint comprises rotating the viewpoint about a virtual location within the virtual three-dimensional surface.

5. A method according to claim 3 comprising iterating c) and d).

6. A method according to claim 1 comprising iterating c) and d).

7. A method according to claim 1 wherein at least one of the sub-categories corresponds to a single specific result.

8. A method according to claim 7, wherein the representation is an image corresponding to a view of a virtual three dimensional surface taken from a viewpoint.

9. A method according to claim 1 wherein in displaying a representation of a search space in dependence upon the initial search query, the search space is selected based on an analysis of the progression of prior searches having in common the same initial search query and a range of time in which the prior searches were executed.

10. A method of searching for content that is stored in a memory of a computer system, comprising:
receiving an initial search query that is provided by a searcher;
retrieving from the memory a set of data relating to results previously generated in dependence upon a same initial search query;
retrieving other data from the memory, the other data relating to a progression of prior searches having in common the same initial search query;
analyzing the set of data and the other data to determine a plurality of sub-categories that are related to the initial search query, the sub-categories for providing the searcher with options to refine the search query;
displaying a representation of the search space for the initial search query, the search space comprising a plurality of data labels, each one of the plurality data labels indicative of one of the determined plurality of sub-categories; and, in response to the searcher selecting one of the data labels distributed on the surface of the three-dimensional solid shape, restricting the search space for the initial search query to those results within the sub-category associated with the selected data label.

11. A method according to claim 10 wherein the representation is an image of a three dimensional surface in which a specific location on the surface corresponds to a subset of the data relating to results generated in dependence upon the initial search query.

12. A method according to claim 10 wherein at least one of the sub-categories corresponds to a single specific result.

13. A method according to claim 10 wherein retrieving and analyzing is performed in dependence upon the other data, the other data automatically updated at intervals.

14. A method according to claim 10 wherein retrieving and analyzing is performed in dependence upon the other data, the other data automatically updated with progression of searches shortly after they are completed.

15. A computer-readable storage medium having stored thereon computer-executable instructions for performing a method of searching for content that is stored on a computer system, the method comprising:
receiving an initial search query that is provided by a searcher;
retrieving from a memory a set of data relating to results previously generated in dependence upon a same initial search query;
retrieving other data from the memory, the other data relating to a progression of prior searches having in common the same initial search query;
analyzing the set of data and the other data to determine a plurality of sub-categories that are related to the initial search query, the sub-categories for providing the searcher with options to refine the search query;
displaying a representation of the search space for the initial search query, the search space comprising a plurality of data labels, each one of the plurality data labels indicative of one of the determined plurality of sub-categories; and, in response to the searcher selecting one of the data labels distributed on the surface of the three-dimensional solid shape, restricting the search space for the initial search query to those results within the sub-category associated with the selected data label.

16. A computer-readable storage medium according to claim 15, wherein the representation is an image of a three dimensional surface in which a specific location on the surface corresponds to a subset of the data relating to results generated in dependence upon the initial search query.

17. A computer-readable storage medium according to claim 15 wherein at least one of the sub-categories corresponds to a single specific result.
